(19) United States
(12) Patent Application Publication
(10) Pub. No.: US 2012/0049042 A1
(43) Pub. Date: Mar. 1, 2012

(54) Pixel Array, Read Out Circuit Therefor, Read Out Architecture Associated Therewith, Image Sensor And System Including The Same

(75) Inventors: Yong Lim, Hwaseong (KR); Kwang Hyun Lee, Seongnam-si (KR)

(73) Assignee: SAMSUNG ELECTRONICS CO., LTD., Suwon-si (KR)

(21) Appl. No.: 13/012,145

(22) Filed: Jan. 24, 2011

(30) Foreign Application Priority Data
Aug. 31, 2010 (KR) 10-2010-0084913

(51) Int. Cl. H01L 27/146; H01L 31/00

(52) U.S. Cl. 250/208.1; 257/440; 257/E27.134

(57) ABSTRACT

In one embodiment of a pixel array, the pixel array includes a plurality of pixels arranged in columns, and a plurality of read out lines are associated with the plurality of pixels such that each column of pixels has at least two read out lines associated therewith. For each column of pixels, the two associated read out lines are configured to transfer signals in a same direction. A read out circuit for a pixel array according to one embodiment includes at least first and second capacitors, and a switching structure configured to selectively connect the first and second read out lines associated with a same column of pixels in the pixel array to the first and second capacitors.

### CROSS-REFERENCE TO RELATED APPLICATIONS

This application claims the benefit of Korean Patent Application No. 10-2010-0084913 filed on Aug. 31, 2010, in the Korean Intellectual Property Office, the disclosure of which is incorporated herein in its entirety by reference.

### BACKGROUND

The present invention relates to a pixel array, readout circuitry, an image sensor and an electronic system including the same, and more particularly, to an image sensor for high-speed output of pixel data and an electronic system including the same.

Image sensors capture images using the characteristic of semiconductor reacting to light. With the recent development of complementary metal-oxide semiconductor (CMOS) technology, CMOS image sensors using CMOS are widely used.

CMOS image sensors use correlated double sampling (CDS), count a result of CDS, e.g., a difference between a reset signal and an image signal, and output a digital signal.

The operating speed of complementary metal-oxide semiconductor (CMOS) image sensors is related with a readout speed, and more particularly, to an average sub-sampling ratio. To increase the operating speed conventionally, only specific pixel structures should be held or chromatic loss or high power consumption should be accepted.

### SUMMARY

Various embodiments relate to one or more of a pixel array; a read out circuit for a pixel array; read out architecture for a pixel array; an image sensor including the pixel array, the read out circuit and/or the read out architecture; and/or a system including the pixel array, the read out circuit, the read out architecture and/or the image sensor.

For example, in one embodiment of a pixel array, the pixel array includes a plurality of pixels arranged in columns, and a plurality of read out lines are associated with the plurality of pixels such that each column of pixels has at least two read out lines associated therewith. For each column of pixels, the two associated read out lines are configured to transfer signals in a same direction.

In another embodiment of the pixel array, the pixel array includes a column of pixels, and at least first and second read out lines are associated with the column of pixels. The first and second read out lines are configured to transfer signals in a same direction.

Further embodiment relates to an image sensor and/or a system including a pixel array according to one of the above described embodiments.

A read out circuit for a pixel array according to one embodiment includes at least first and second capacitors, and a switching structure configured to selectively connect first and second read out lines associated with a same column of pixels in the pixel array to the first and second capacitors. For example, the switching structure is configured to selectively connect the first and second capacitors in parallel to one of the first read out line and the second read out line in a first mode, and selectively connect the first read out line to the first capacitor and the second read out line to the second capacitor in a second mode.

In another embodiment, the read out circuit further includes third and fourth capacitors, and the switching structure is configured to selectively connect the first and second read out lines to the first, second, third and fourth capacitors. For example, in a one mode, the switching structure is configured to selectively connect the first, second, third and fourth capacitors to the first and second read out lines such that signals on the first and second read out lines are combined according to a weighted average. As another example, in another mode, the switching structure is configured to selectively connect the first, second, third and fourth capacitors to the first and second read out lines such that signals on the first and second read out lines are averaged.

Embodiments also relate to a read out architecture for a pixel array. One embodiment of a read out architecture includes a plurality of read out circuits, each read out circuit being according to one of the above described embodiments.

Further embodiment relates to an image sensor and/or a system including a read out circuit and/or read out architecture according to one of the above described embodiments.

Still further embodiments relate to methods of reading information from a pixel array.

In one embodiment, the method includes, in a normal mode, selectively connecting at least first and second capacitors in parallel, and selectively connecting one of a first read out line and a second read out line to the first and second capacitors connected in parallel. Here, the first and second read out lines are associated with a same column of pixels. In a combination mode, the method includes selectively connecting the first read out line to the first capacitor, and selectively connecting the second read out line to the second capacitor.

In another embodiment, the method includes, in a normal mode, selectively connecting a plurality of capacitors in parallel, and selectively connecting one of a first read out line and a second read out line to the plurality of capacitors connected in parallel. Here, the first and second read out lines are associated with a same column of pixels. In a combination mode, the method includes selectively connecting the first read out line to a first number of the plurality capacitors in parallel, and selectively connecting the second read out line to a second number of the plurality of capacitors in parallel.

In a still further embodiment, the method includes, in a normal mode, reading out a signal from a pixel in a first group of pixels in a column of pixels using a first read out line and one of a plurality of read out circuits, and subsequently reading out a signal from a pixel in a second group of pixels in the column of pixels using a second read out line and the one of the plurality of read out circuits. In a combination mode, the method includes reading out a signal from pixels in the first and second groups of pixels using the first and second read out lines, and combining the read signals from the first and second read out lines.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic block diagram for explaining an image sensor according to some embodiments;

FIG. 2 is a detailed diagram of a pixel array illustrated in FIG. 1 according to an embodiment;

FIG. 3 is a diagram of the CDS and ADC according to an embodiment;

FIG. 4 is a diagram showing a first operation of the CDS and ADC according to an embodiment;

FIG. 5 is a diagram showing a second operation of the CDS and ADC according to an embodiment;

FIG. 6 is a diagram showing a third operation of the CDS and ADC according to an embodiment;

FIG. 7 is a diagram showing the third operation of the CDS and ADC illustrated in FIG. 6 in detail;

FIG. 8 is a diagram showing the CDS and the ADC according to another embodiment;

FIGS. 9-13 are diagrams showing example operations of the CDS and ADC in FIG. 8; and

FIG. 14 is a block diagram of an electronic system including an image sensor according to some embodiments.

### DETAILED DESCRIPTION OF THE EMBODIMENTS

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

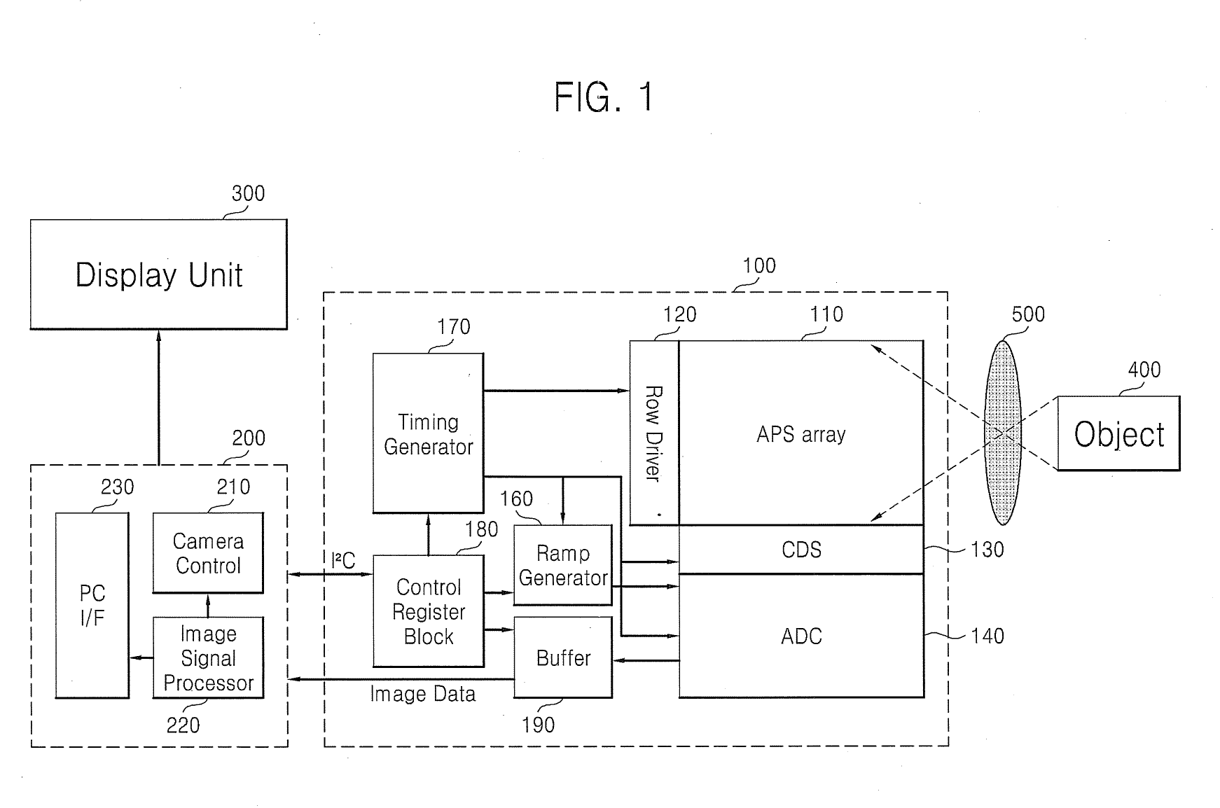

FIG. 1 is a schematic block diagram for explaining an image sensor 100 according to some embodiments. Referring to FIG. 1, the image sensor 100 includes a pixel array (e.g., an active-pixel sensor (APS) array) 110, a row driver 120, a correlated double sampling (CDS) block 130, an analog-to-digital converter (ADC) 140, a ramp generator 160, a timing generator 170, a control register block 180, and a buffer 190.

The image sensor 100 is controlled by an image processor (e.g., a digital image processor (DSP)) 200 to sense an object 400 picked up through a lens 500 and the image processor 200 outputs an image sensed and output by the image sensor 100 to a display unit 300. At this time, the display unit 300 may be any device that can output an image. For instance, the display unit 300 may be a computer, a mobile phone, or any type of image display terminal.

The image processor 200 includes a camera control or controller 210, an image signal processor 220, and a persona computer (PC) interface (I/F) 230. The camera controller 210 controls the control register block 180. The camera control 210 may control the image sensor 100, and more specifically, the control register block 180 by supplying instructions over an interface operating according to a communication protocol such as the inter-integrated circuit (I²C) protocol.

The image signal processor 220 receives image data, i.e., an output signal of the buffer 190, processes the image data so that people can see an image, and outputs the image to the display unit 300 through PC I/F 230. The image signal processor 220 is disposed within the image processor 200 in the embodiments illustrated in FIG. 1, but the design may be modified by those skilled in the art. For instance, the image signal processor 220 may be disposed within the image sensor 100.

The pixel array 110 includes a plurality of photo sensitive devices, for example, photo diodes or pinned photo diodes. The pixel array 110 senses light using the photo sensitive devices and converts the light into an electrical signal, i.e., an image signal.

The timing generator 170 outputs a control signal to the row driver 120, the ADC 140, and the ramp generator 160 to control the operations thereof. The control register block 180 outputs a control signal to the ramp generator 160, the timing generator 170, and the buffer 190 to control the operations thereof. The control register block 180 is controlled by the camera control 210.

The row driver 120 drives the pixel array 110 in units of rows. For instance, the row driver 120 may generate a row selection signal. The pixel array 110 outputs to the CDS block 130 a reset signal and an image signal from a row selected by the row selection signal received from the row driver 120. The CDS block 130 performs CDS on the reset signal and the image signal.

The ADC 140 compares a ramp signal Vramp output from the ramp generator 160 with a CDS signal output from the CDS block 130, generates and counts a comparison result signal, and outputs a digital signal to the buffer 190. In this manner, the CDS 130 and the ADC 140 serve as the read out circuitry for the pixel array 110.

The buffer 190 temporarily stores a digital signal output from the ADC 140 and senses and amplifies the digital signal before outputting the digital signal. The buffer 190 may include a column memory block including a plurality of memories, e.g., static random access memories (SRAMs), at least one for each column, for temporal storing. The buffer 190 may also include a sense amplifier sensing and amplifying the digital signal received from the ADC 140.

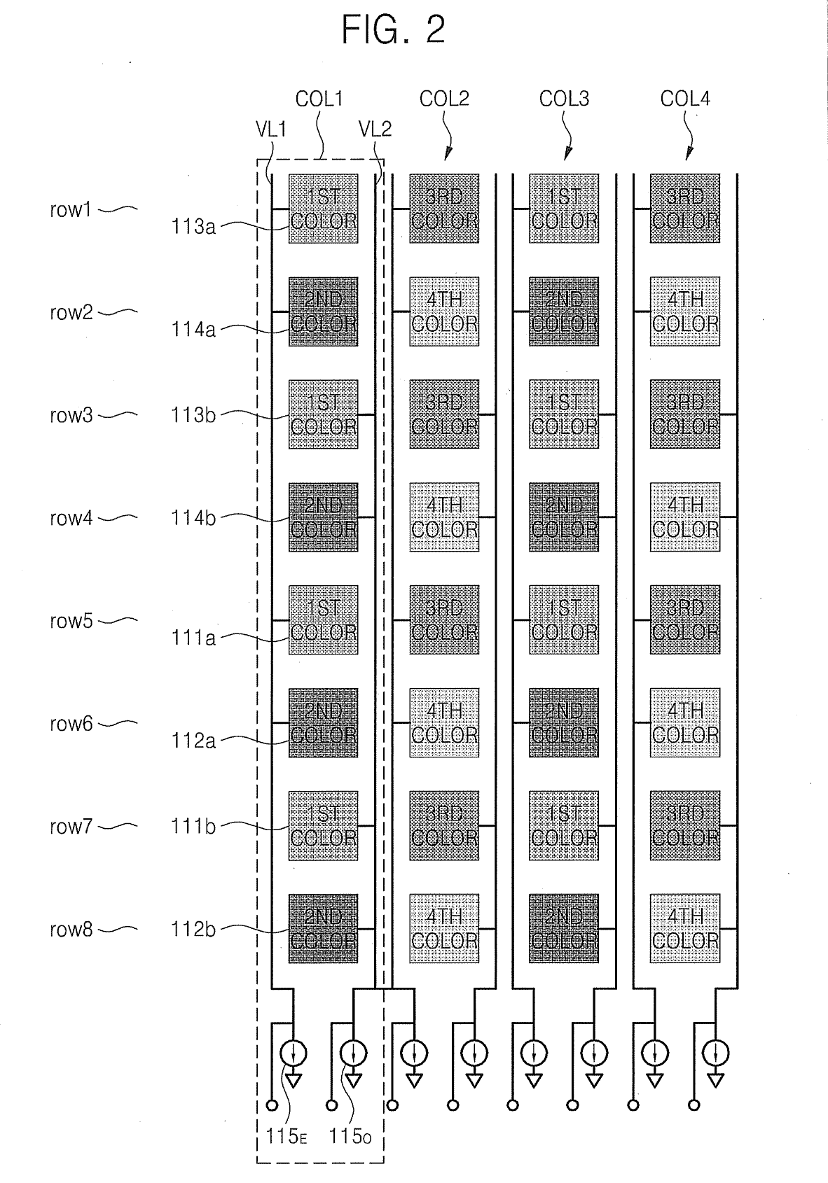

FIG. 2 is a detailed diagram of the pixel array 110 illustrated in FIG. 1 according to an embodiment. The pixel array 110 usually includes several hundreds to thousands of rows and columns or more, but for clarity of the description only first to fourth columns COL1 through COL4 among a plurality of columns and only pixels in first through eighth rows row1 through row8 of each column among a plurality of pixels are illustrated in FIG. 2. Each pixel may have any well-known structure, for example, such as described in U.S. application Ser. No. 12/062,552; which is hereby incorporated by reference in its entirety.

Referring to FIG. 2, the pixel array 110 includes two readout lines, i.e., a first readout line VL1 and a second readout line VL2 for each column. All pixels in the first column COL1 are connected either to the first readout line VL1 or to the second readout line VL2, and a first group of pixels among all the pixels in the first column COL1 is connected to the first readout line VL1 and a second group of pixels among all pixels in the second column COL2 is connected to the second readout line VL2.

When more than two readout lines are provided for each column, all pixels in each column may be divided into as many groups as the number of readout lines and each pixel may be connected to one of the readout lines according to the group to which the pixel belongs.

While conventional image sensors include a single readout line for each column in a pixel array, the pixel array 110 may include N readout lines (where N is 2 or an integer greater than 2) for each column in the current embodiments of the present invention.

Referring back to FIG. 2, two readout lines, i.e., the first and second readout lines VL1 and VL2 are provided for the first column COL1 A plurality of pixels (e.g., 111a through 114a and 111b through 114b) in the first column COL1 are connected to either of the first and second readout lines VL1 and VL2. The first and second readout lines VL1 and VL2 are respectively connected to bias current sources 115_{E} and 115_{O}.

The color pixels 111a, 112a, 113a and 114a are connected to the first readout line VL1 and the color pixels 111b, 112b, 113b and 114b are connected to the second readout line VL2. The color pixels 111a, 112a, 113a and 114a may belong to the first group and the color pixels 111b, 112b, 113b and 114b may belong to the second group. At this time, the color pixels of the first and second groups may be connected to either of the first and second readout lines VL1 and VL2, respectively, according to a desired (or, alternatively a predetermined) pattern.

The desired pattern may be “adjacent” or consecutive same colors are respectively connected to different readout lines. Here, being “adjacent” or consecutive means that pixels of the same color are right beside each other or there is no pixel of the same color between the pixels of the same color. For instance, since the second color pixel 114b is between the first color pixels 111a and 113b and no other first color pixel is between the first color pixels 111a and 113b, the first color pixels 111a and 113b are “adjacent” or consecutive same color pixels. Contrarily, there is the first color pixel 113b between the first color pixels 111a and 113a, and therefore, the first color pixels 111a and 113a are not “adjacent” or consecutive same color pixels.

The pixel 111a in the first pixel group and the pixel 111b in the second pixel group are adjacent to each other and have the same color and are thus connected to different readout lines, respectively. In other words, the pixel 111a is connected to the first readout line VL1 and the pixel 111b is connected to the second readout line VL2. However, if the two pixels 111a and 111b are respectively connected to different readout lines, the pixels 111a and 111b are not necessarily connected to the first readout line VL1 and the second readout line VL2, respectively. In other words, the pixel 111a may be connected to the second readout line VL2 and the pixel 111b may be connected to the first readout line VL1.

When the pixels 111a through 114a and 111b through 114b in the first column COL1 are divided into groups so that each group consists of N (e.g., 2) adjacent pixels of the same color, the N pixels are respectively connected to N different readout lines corresponding to the first column COL1.

The pixel array 110 including two readout lines for each column has been described in the embodiments illustrated in FIG. 2, but the present invention is not restricted to the current embodiments. The present invention is also effective for a pixel array including more than two readout lines for each column. For instance, when four readout lines are used, four adjacent pixels of the same color are connected to four different readout lines, respectively.

In addition, it is apparent that the pixel array 110 may have various patterns (e.g., complement pattern, BGRE pattern, CYYM pattern, CYGM pattern, and RGBW pattern) besides a Bayer pattern.

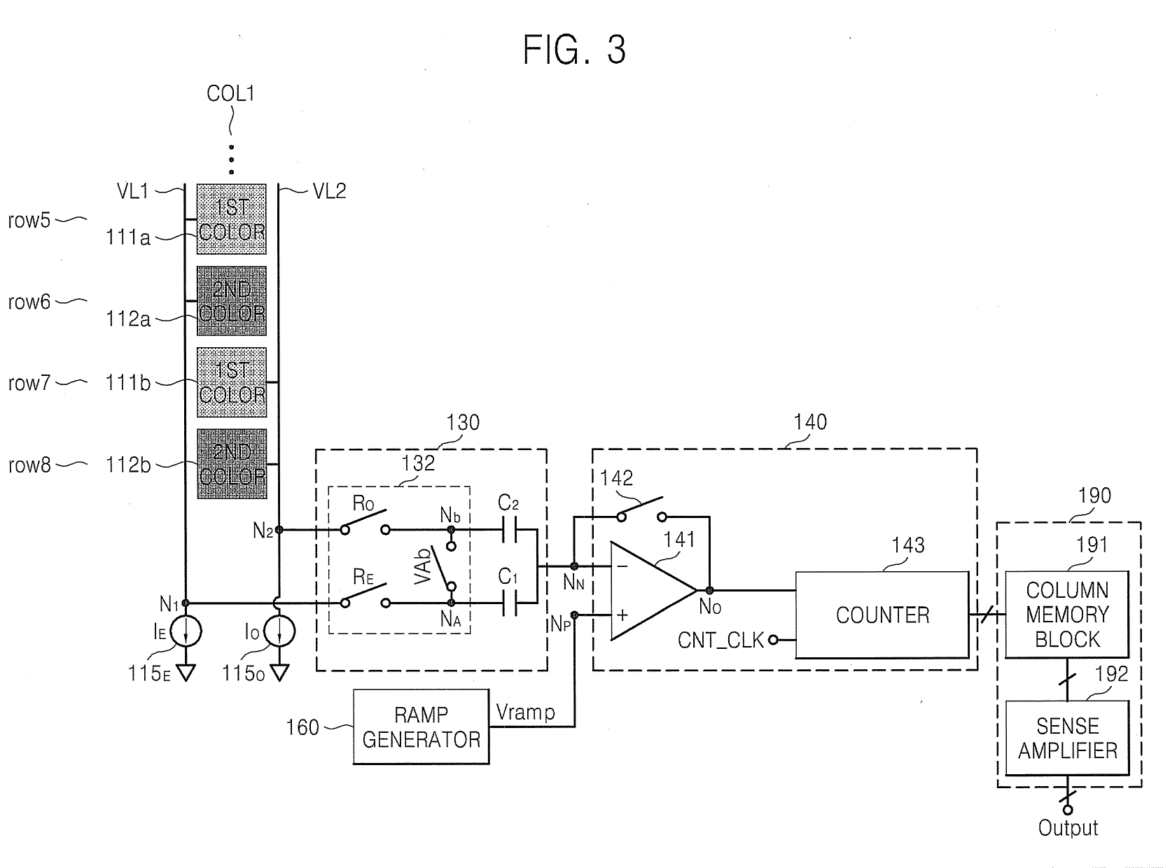

FIG. 3 is a diagram showing the CDS block 130 and the ADC 140 according to an embodiment. The CDS block 130 and the ADC 140 illustrated in FIG. 3 are connected to the first column COL1 illustrated in FIG. 2 and only the fifth through eighth rows row5 through row8 of the first column COL1 illustrated in FIG. 2 is shown in FIG. 3. Referring to FIG. 3, the ADC 140 includes a comparator 141 and a counter 143.

The comparator 141 is connected to the first and second readout lines VL1 and VL2. In detail, a first input terminal N_{N} of the comparator 141 is connected to the first readout line VL1 via a first switch R_{E} and a first capacitor C₁ in the CDS block 130, and the first input terminal N_{N} is connected to the second readout line VL2 via a second switch R_{O} and a second capacitor C₂ in the CDS block 130. The first and second capacitors C₁ and C₂ may have the same capacitance value. A third switch VAb in the CDS block 130 selectively connects a first node N_{A}, connected between the first switch R_{E} and the first capacitor C₁, and a second node N_{b}, connected between the second switch R_{O} and the second capacitor C₂. The first switch R_{E}, second switch R_{O} and third switch VAb form a switching architecture 132. A second input terminal N_{P} of the comparator 141 receives the ramp signal Vramp from the ramp generator 160. A switch 142 for negative feedback switching is connected between the first input terminal N_{N} and an output terminal N_{O} of the comparator 141.

When the switch 142 is switched, for instance, according to the switching of the first switch R_{E} and the second switch R_{O}, the comparator 141 compares the ramp signal with a potential generated when the first capacitor C₁ and/or the second capacitor C₂ are charged with charges, for example, from the pixels 111a and 111b in the first column COL1 and outputs a comparison result signal to the output terminal N_{O}. In the embodiments (illustrated in FIGS. 1 through 8) of the present invention, the charges are from the first color pixels 111a and 111b, but the present invention is not restricted to these embodiments. For instance, the first capacitor C₁ and/or the second capacitor C₂ may be charged with charges from the second color pixels 112a and 112b.

The comparison result signal output from the comparator 141 may be a difference between a reset signal (detected noise) and an image signal, which changes according to the illumination of external light. The ramp signal Vramp is used to output a digital value representing the difference between the image signal and the reset signal. This difference is detected and may be output according the slope of the ramp signal Vramp.

The counter 143 is connected to the output terminal N_{O} of the comparator 141 and counts the comparison result signal during a counting period according to an input clock signal CNT_CLK to output a digital signal. At this time, the counter 143 may be an up/down counter or a bit-wise inversion counter. The bit-wise inversion counter may perform similar operation to the up/down counter. For instance, the bit-wise inversion counter not only counts up but also inverts all bits in the counter to convert them into 1's complement when a particular signal is received. Accordingly, after obtaining bits according to a reset count, the bit-wise inversion counter can convert the bits into the 1's complement, i.e., a negative value.

As described above, the buffer 190 includes a column memory block 191 and a sense amplifier 192. The column memory block 191 temporarily stores a digital signal output from the counter 143 and then outputs the digital signal to the sense amplifier 192. The sense amplifier 192 senses and amplifies the digital signal before outputting the digital signal.

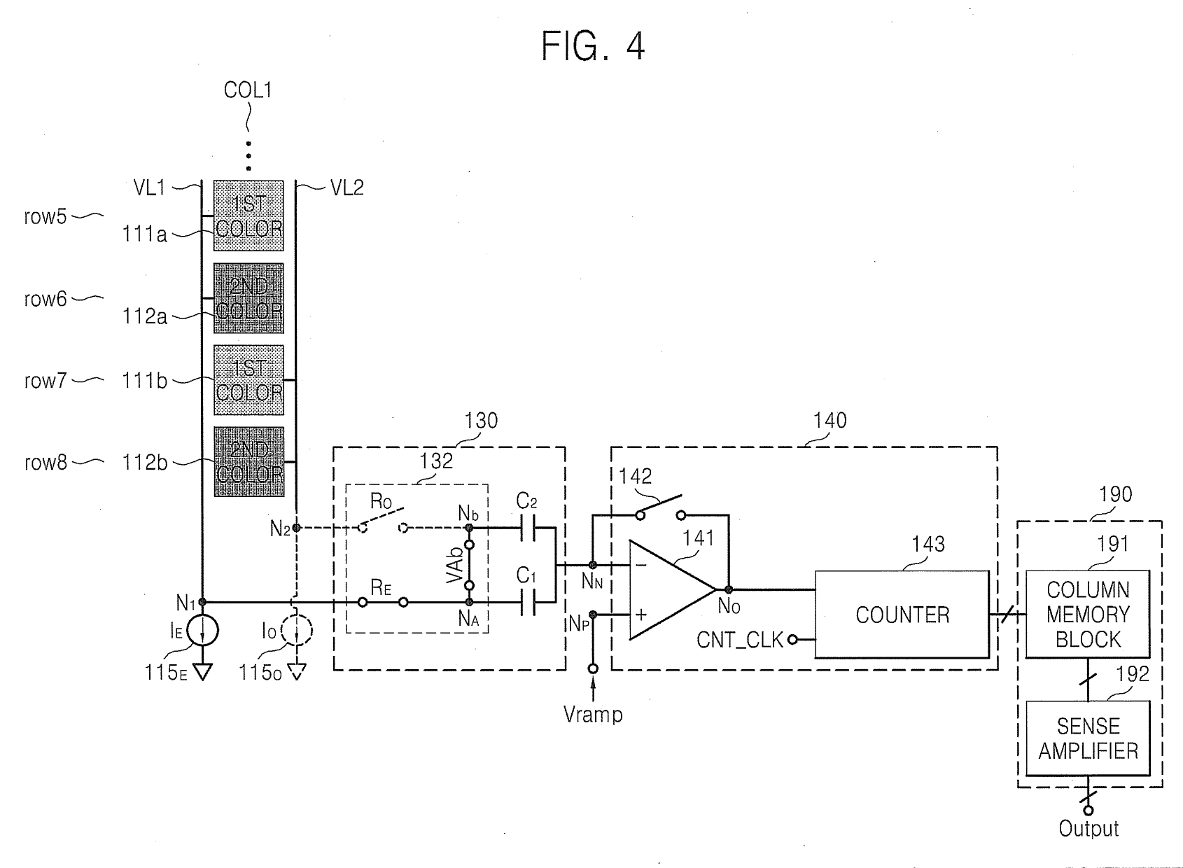

FIGS. 4 through 6 show first through third operations of the CDS block 130 and the ADC 140 according to some embodiments. The operations illustrated in FIGS. 4 through 6 may be performed by the CDS block 130 and the ADC 140 illustrated in FIG. 3. The first, the second or the third operation is decided according to a control signal that the row driver 120 and the CDS block 130 receive from the timing generator 170 illustrated in FIG. 1.

FIG. 4 is a diagram showing the first operation of the CDS block 130 and the ADC 140 according to an embodiment. This operation mode may be referred to as a normal mode for reading the first readout line VL1. Referring to FIG. 4, when the first switch R_{E} is closed and the second switch R_{O} is open, the second readout line VL2 is not connected to the first capacitor C₁ and/or the second capacitor C₂. Instead, only the first readout line VL1 is connected to first capacitor C₁ and/or the second capacitor C₂. At this time, the third switch VAb is closed, connecting the first capacitor C₁ with the second capacitor C₂ in parallel so that a large capacitance (C′=C₁*C₂/C₁+C₂) is provided.

The first and second capacitors C₁ and C₂ are charged with charge output from the pixel 111a connected to the first readout line VL1. When the switch 142 is closed, the comparator 141 compares a potential generated by the charge with the ramp signal Vramp input to the second input terminal N_{P} and outputs a comparison result signal to the output terminal N_{O}. The operations of the counter 143 and the column memory block 191 are the same as those described with reference to FIG. 3. Thus, descriptions thereof will be omitted here.

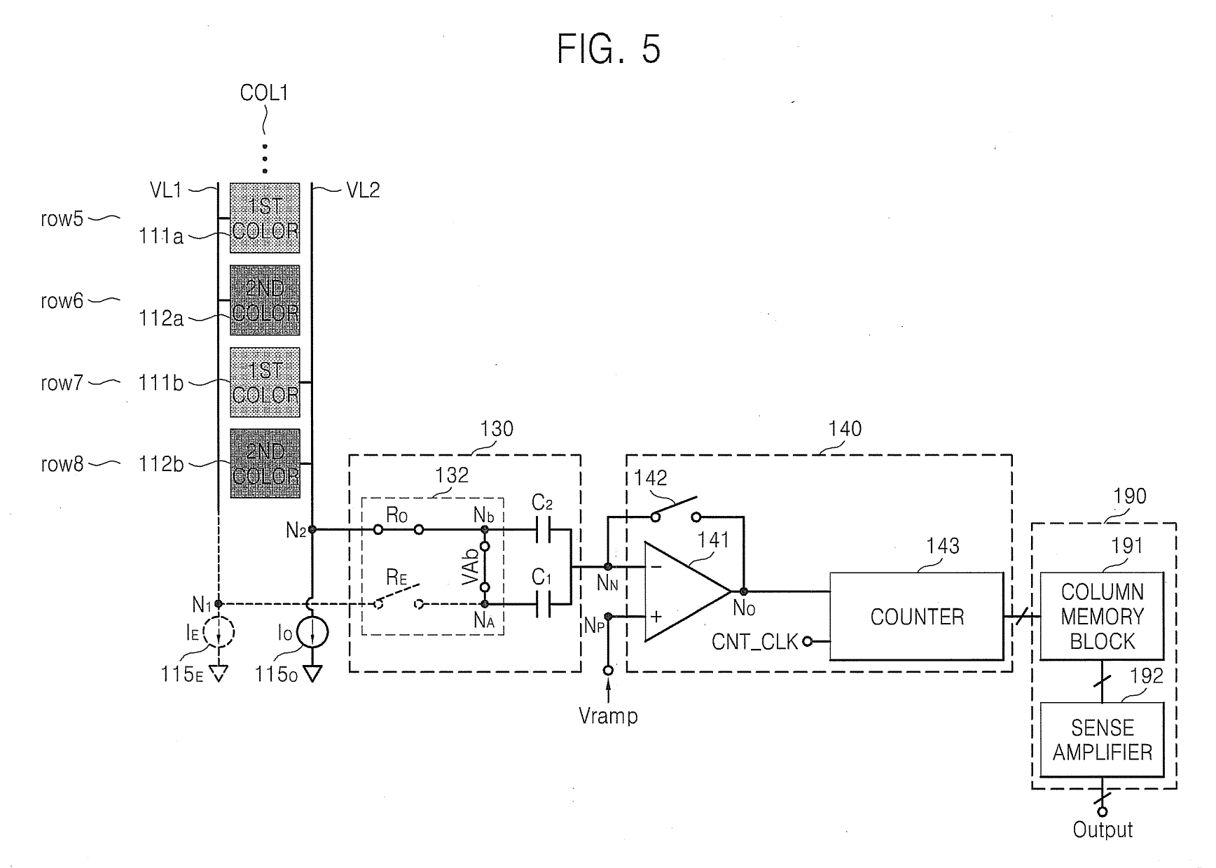

FIG. 5 is a diagram showing the second operation of the CDS block 130 and the ADC 140 according to an embodiment. This operation mode may be referred to as a normal mode for reading the second readout line VL2. Referring to FIG. 5, when the first switch R_{E} is open and the second switch R_{O} is closed, the first readout line VL1 is not connected to the first capacitor C₁ and/or the second capacitor C₂. Instead, only the second readout line VL2 is connected to the first capacitor C₁ and/or the second capacitor C₂. At this time, the third switch VAb is closed, connecting the first capacitor C₁ with the second capacitor C₂ in parallel so that a large capacitance (C″=C₁*C₂/C₁+C₂) is provided.

The first and second capacitors C₁ and C₂ are charged with charge output from the pixel 111b connected to the second readout line VL2. When the switch 142 is closed, the comparator 141 compares a potential generated by the charge with the ramp signal Vramp input to the second input terminal N_{P} and outputs a comparison result signal to the output terminal N_{O}. The operations of the counter 143 and the column memory block 191 are the same as those described with reference to FIG. 3. Thus, descriptions thereof will be omitted here.

The first and second operations illustrated in FIGS. 4 and 5 are performed in a normal mode. Through these operations, the first readout line VL1 and the second readout line VL2 are alternately selected by control signals that the row driver 120 and the CDS block 130 receive from the timing generator 170, so that the first capacitor C₁ and the second capacitor C₂ are charged with charges output from all pixels in the first column COL1.

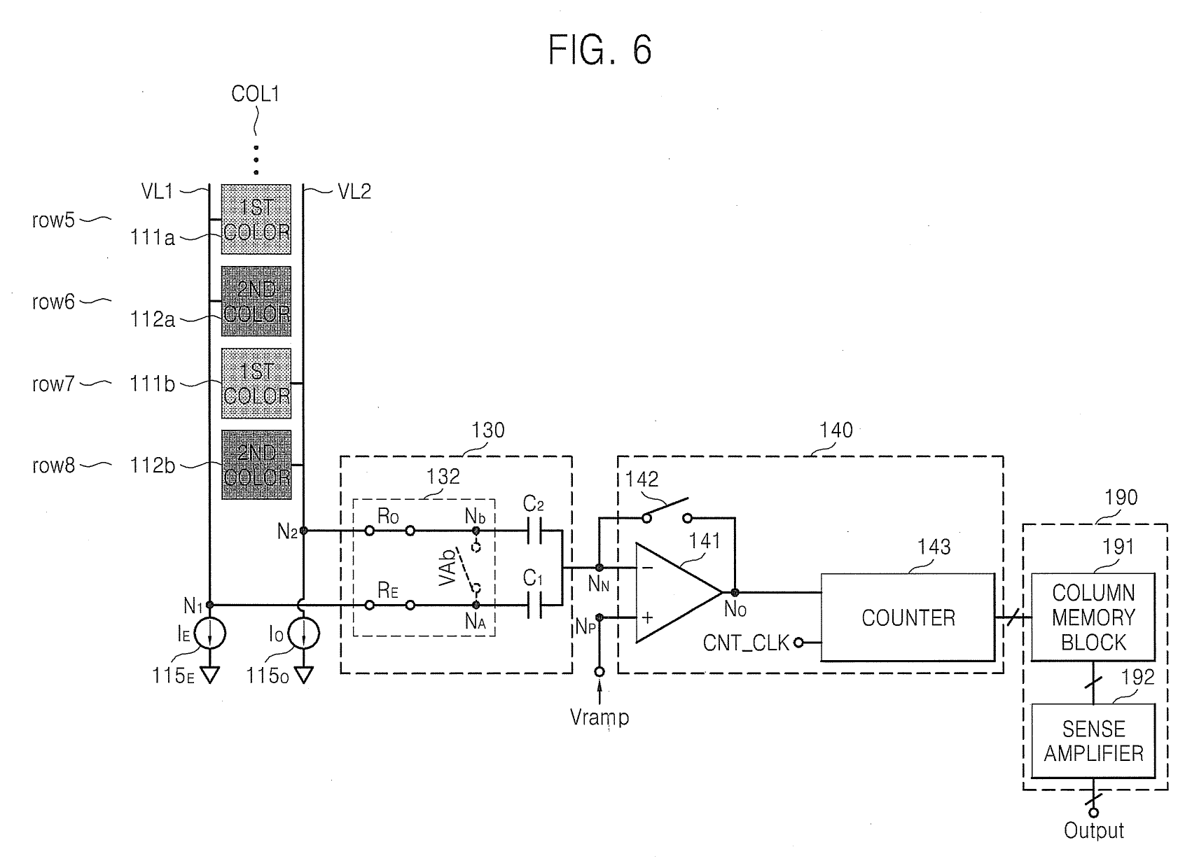

FIG. 6 is a diagram showing the third operation of the CDS block 130 and the ADC 140 according to an embodiment. The third operation is high-speed averaging.

Referring to FIG. 6, the first switch R_{E} and the second switch R_{O} are both closed, the first readout line VL1 is connected to the first capacitor C₁, and the second readout line VL2 is connected to the second capacitor C₂. The third switch VAb is open. The first capacitor C₁ is charged with charge output from the pixel 111a connected to the first readout line VL1 and the second capacitor C₂ is charged with charge output from the pixel 111b connected to the second readout line VL2.

When the switch 142 is closed, a potential generated at the first input terminal N_{N} of the comparator 141 by charges in the first and second capacitors C₁ and C₂ is half, i.e., an average of the sum of a potential generated by the charge in the first capacitor C₁ and a potential generated by the charge in the second capacitor C₂ if the first capacitor C₁ and the second capacitor C₂ have the same capacitance. The comparator 141 compares the average with a value of the ramp signal Vramp input to the second input terminal N_{P} and outputs a comparison result signal to the output terminal N_{O}.

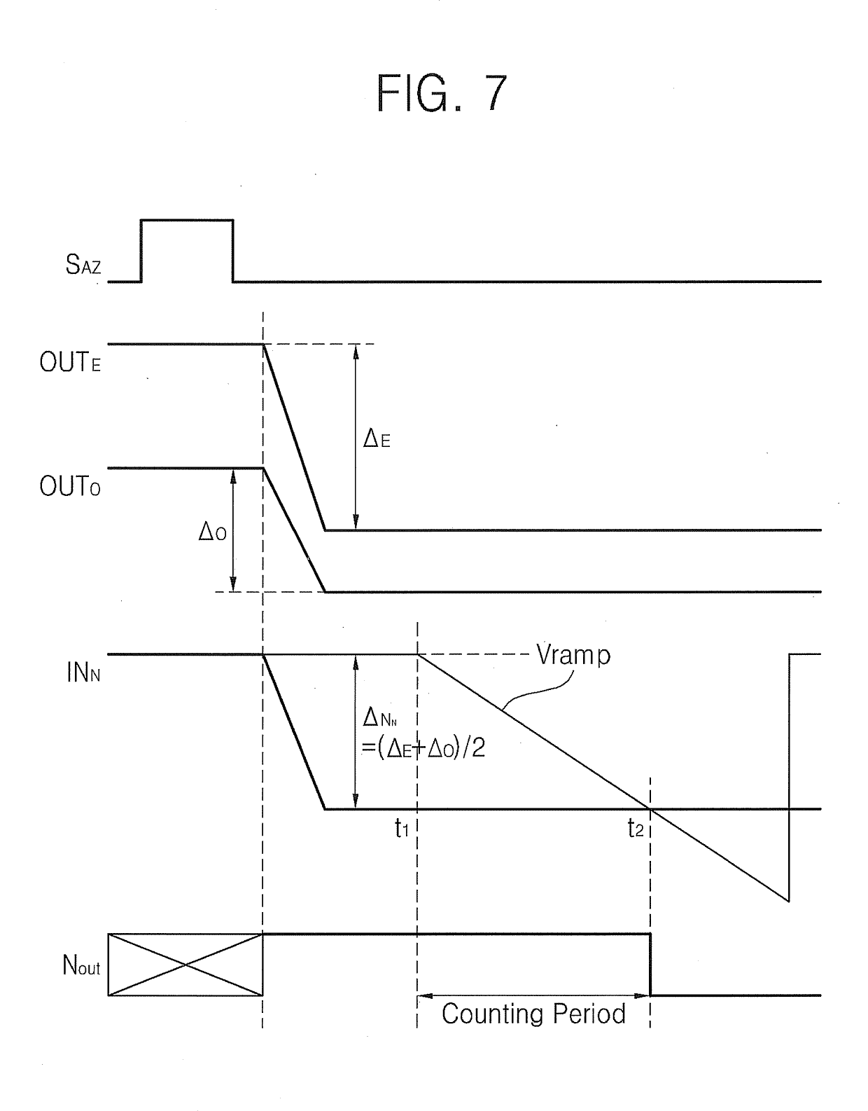

The third operation will be described in detail with reference to FIG. 7. The operations of the counter 143 and the column memory block 191 are the same as those described with reference to FIG. 3. Thus, descriptions thereof will be omitted here.

FIG. 7 is a diagram schematically showing waveforms of main signals to explain in detail the third operation illustrated in FIG. 6. The five waveforms illustrated in FIG. 7 are, sequentially from the top, a waveform of a control signal S_{AZ} from the timing generator 170 controlling the switch 142, a potential waveform OUT_{E} at a first readout line connection node N₁, a potential waveform OUT_{O} at a second readout line connection node N₂, a potential waveform IN_{N} at the first input terminal N_{N}, and a potential waveform N_{OUT} at the output terminal N_{O}.

Referring to FIG. 7, when the switch 142 is closed by the signal S_{AZ}, a charge from the pixel 111a is transferred to the first capacitor C₁ and a charge from the pixel 111b is transferred to the second capacitor C₂. As a result, potentials Δ_{E} and Δ_{O} are respectively generated at the first readout line connection node N₁ and the second readout line connection node N₂ and a potential ((Δ_{E}+Δ_{O})/2) corresponding to about half of the sum of the potentials Δ_{E} and Δ_{O} is generated at the first input terminal N_{N}. Accordingly, the potential of the first input terminal N_{N} is (Δ_{E}+Δ_{O})/2 less than a potential generated at the first input terminal N_{N} before the switch 142 is closed by the signal S_{AZ}.

The comparator 141 compares the potential of the first input terminal N_{N} with the ramp signal Vramp to detect whether the ramp signal Vramp is lower than the potential of the first input terminal N_{N} and outputs a comparison result signal. For instance, when the ramp signal Vramp starts decreasing at a first point “t1” and becomes lower than the potential of the first input terminal N_{N} at a second point “t2”, as illustrated in FIG. 7. The comparator 141 outputs as a comparison result a logic high when the ramp signal Vramp is higher than the potential of the first input terminal N_{N} and outputs a logic low when the ramp signal Vramp is lower than the potential of the first input terminal N_{N}.

The counter 143 counts the comparison result signal during a counting period from the first point “t1” to the second point “t2” according to the clock signal CNT_CLK and outputs a digital signal. For instance, if the clock signal CNT_CLK input to the counter 143 toggles five times during the counting period, the counter 143 may count “11111” and output this to the column memory block 191.

The combination mode of operation does not provide the same resolution as the normal mode, but provides much greater speed. The combination mode may be preferable when using the image sensor to record a movie as opposed to still pictures.

As described above, the embodiments of the present invention provide at least two readout lines for each column in an image sensor, thereby realizing high-speed operation during average sub-sampling in which data is read from pixels connected to each column at a time. As a result, the image sensor can provide high quality of pictures at high speed. Because only one CDS 130 and ADC 140 are provided for multiple read out lines (e.g., two), less power and less chip real state are consumed.

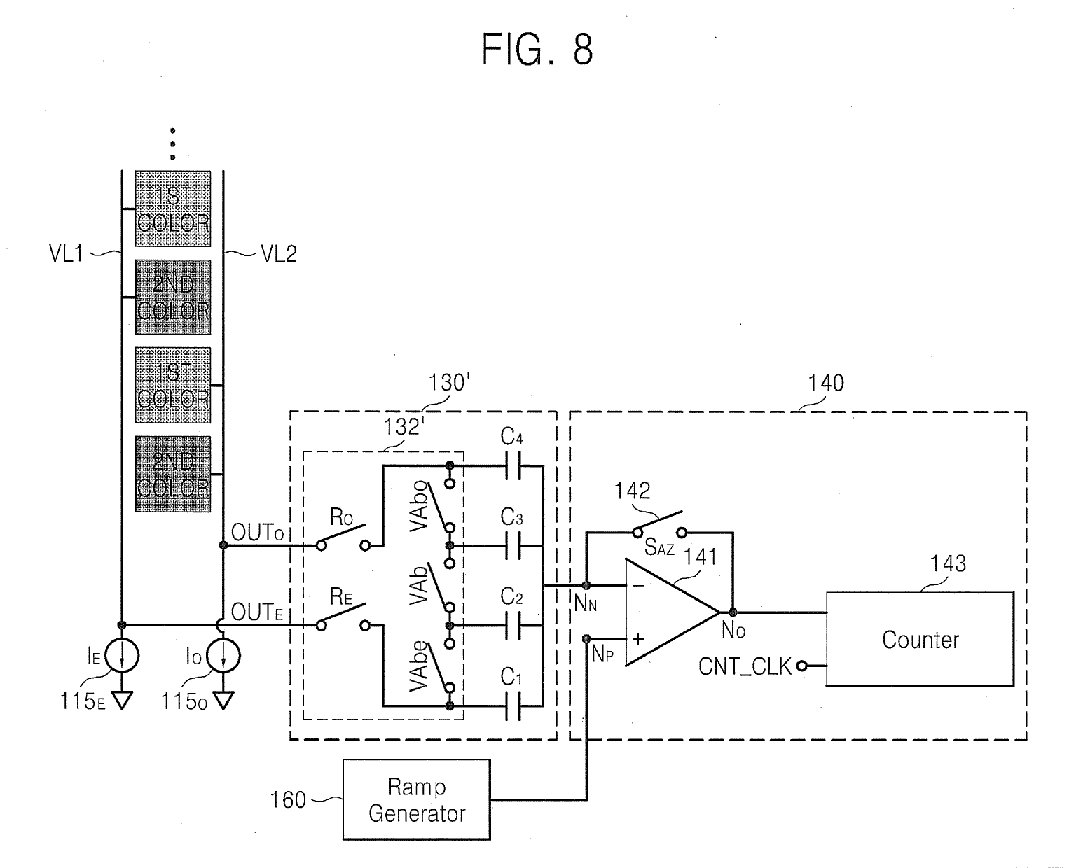

FIG. 8 is a diagram showing the CDS and the ADC according to another embodiment. The embodiment of FIG. 8 is the same as the embodiment of FIG. 3 except that the CDS block 130 in FIG. 3 has been replaced with the CDS block 130′ in FIG. 8. Accordingly, for the sake of brevity, only these differences will be described in detail.

As shown, the CDS block 130′ includes first, second, third and fourth capacitors C1, C2, C3, and C4 connected to the first, negative input terminal N_{N} the comparator 141. A first switch R_{E} selectively connects the first read out line VL1 to the first capacitor C1, and a second switch R_{O} selectively connects the second read out line VL2 to the fourth capacitor C4. A third switch VAbe selectively connects the first and second capacitors C1 and C2, a fourth switch VAb selectively connects the second and third capacitors C2 and C3, and a fifth switch VAbo selectively connects the third and fourth capacitors C3 and C4. The switches are controlled by control signals from the timing generator 170, and form a switching architecture 132′.

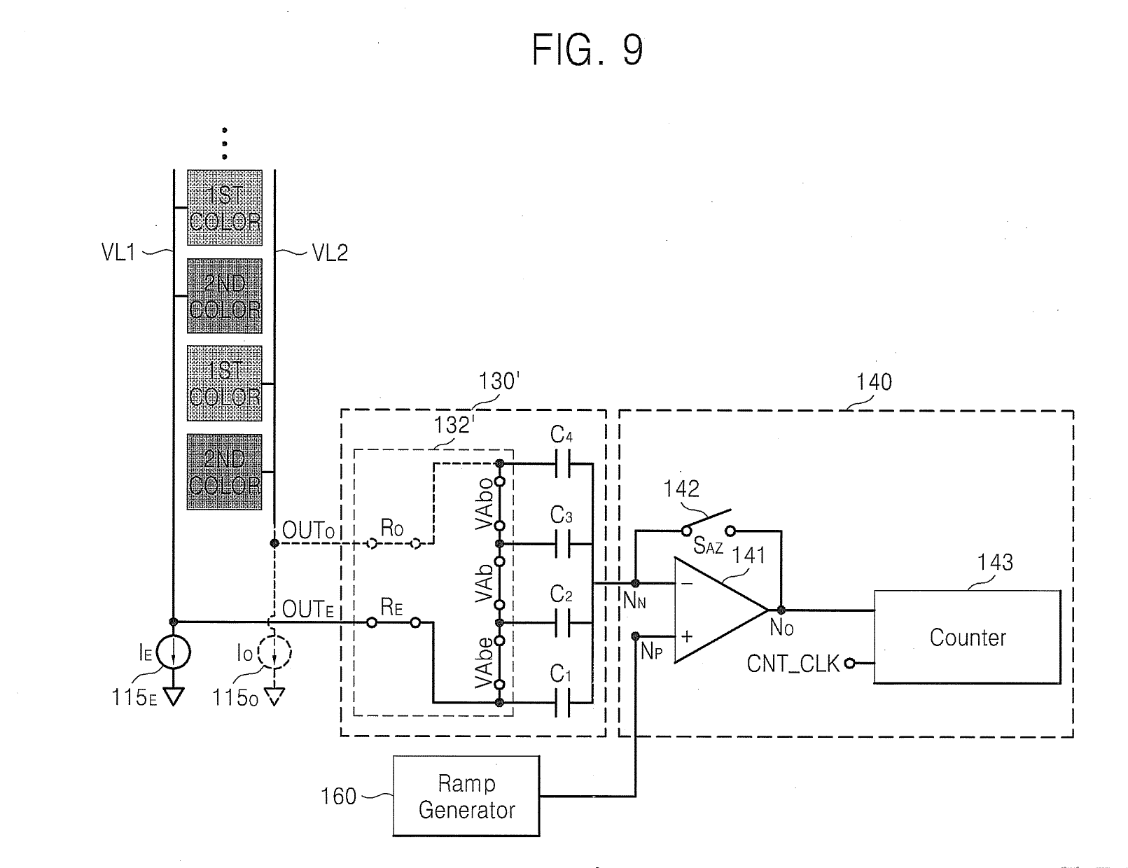

FIGS. 9-13 are diagrams showing operation of the CDS and ADC in FIG. 8 according to some example embodiments.

FIG. 9 shows the normal mode for reading from the first readout line VL1. As shown, in this mode, the first switch R_{E} is closed, the second switch R_{O} is open, and the third through fifth switches VAbe, VAb, and VAbo are closed. As such, the first through fourth capacitors C1, C2, C3 and C4 are connected in parallel to the first readout line VL1, and a large capacitance (C′=C1*C2*C3*C4/C1+C2+C3+C4) is provided.

The first through fourth capacitors C1, C2, C3 and C4 are charged with charge output from a pixel connected to the first readout line VL1. When the switch 142 is closed, the comparator 141 compares a potential generated by the charge with the ramp signal Vramp input to the second, positive input terminal N_{P} and outputs a comparison result signal to the output terminal N_{O}. The operations of the counter 143 and the column memory block 191 are the same as those described with reference to FIG. 3. Thus, descriptions thereof will be omitted here.

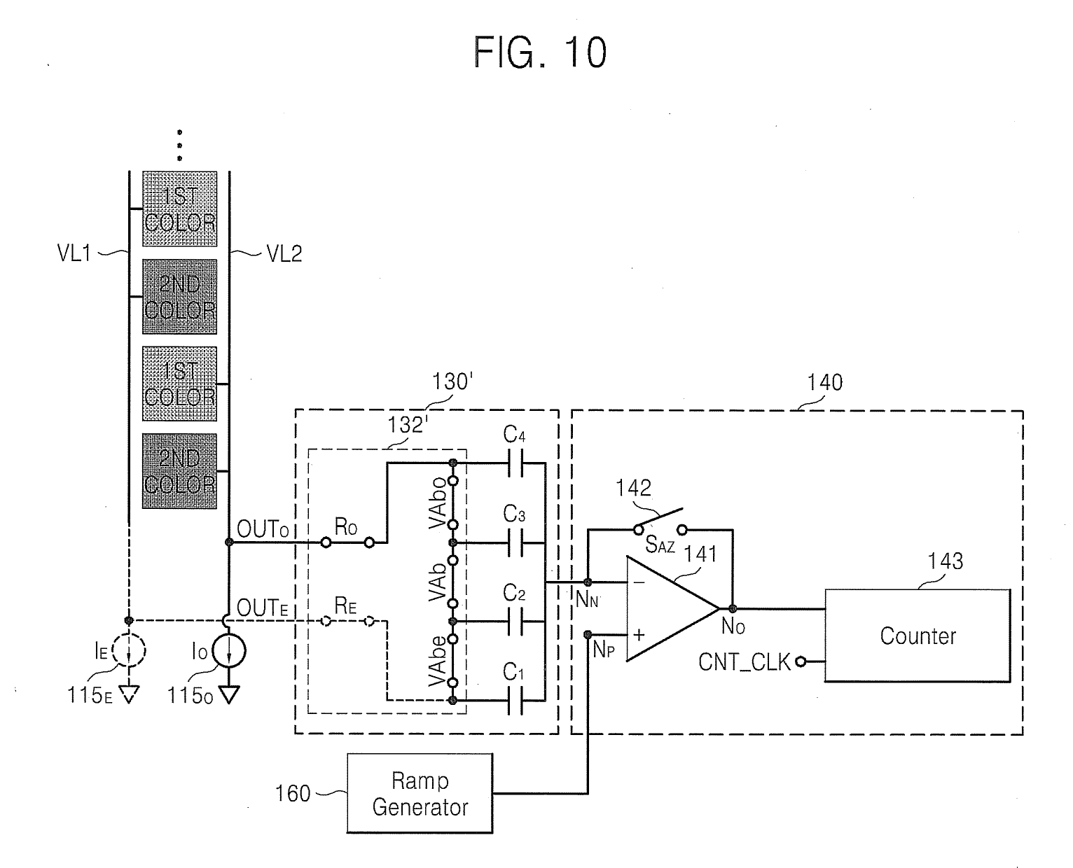

FIG. 10 shows the normal mode for reading from the second readout line VL2. As shown, in this mode, the second switch R_{O} is closed, the first switch R_{E} is open, and the third through fifth switches VAbe, VAb, and VAbo are closed. As such, the first through fourth capacitors C1, C2, C3 and C4 are connected in parallel to the second readout line VL2, and the large capacitance (C′=C1*C2*C3*C4/C1+C2+C3+C4) is provided.

The first through fourth capacitors C1, C2, C3 and C4 are charged with charge output from a pixel connected to the second readout line VL2. When the switch 142 is closed, the comparator 141 compares a potential generated by the charge with the ramp signal Vramp input to the second input terminal N_{P} and outputs a comparison result signal to the output terminal N_{O}. The operations of the counter 143 and the column memory block 191 are the same as those described with reference to FIG. 3. Thus, descriptions thereof will be omitted here.

The first and second operations illustrated in FIGS. 9 and 10 are performed in a normal mode. Through these operations, the first readout line VL1 and the second readout line VL2 are alternately selected by control signals that the row driver 120 and the CDS block 130′ receive from the timing generator 170, so that the first through fourth capacitors C1, C2, C3 and C4 are charged with charges output from all pixels in the first column COL1.

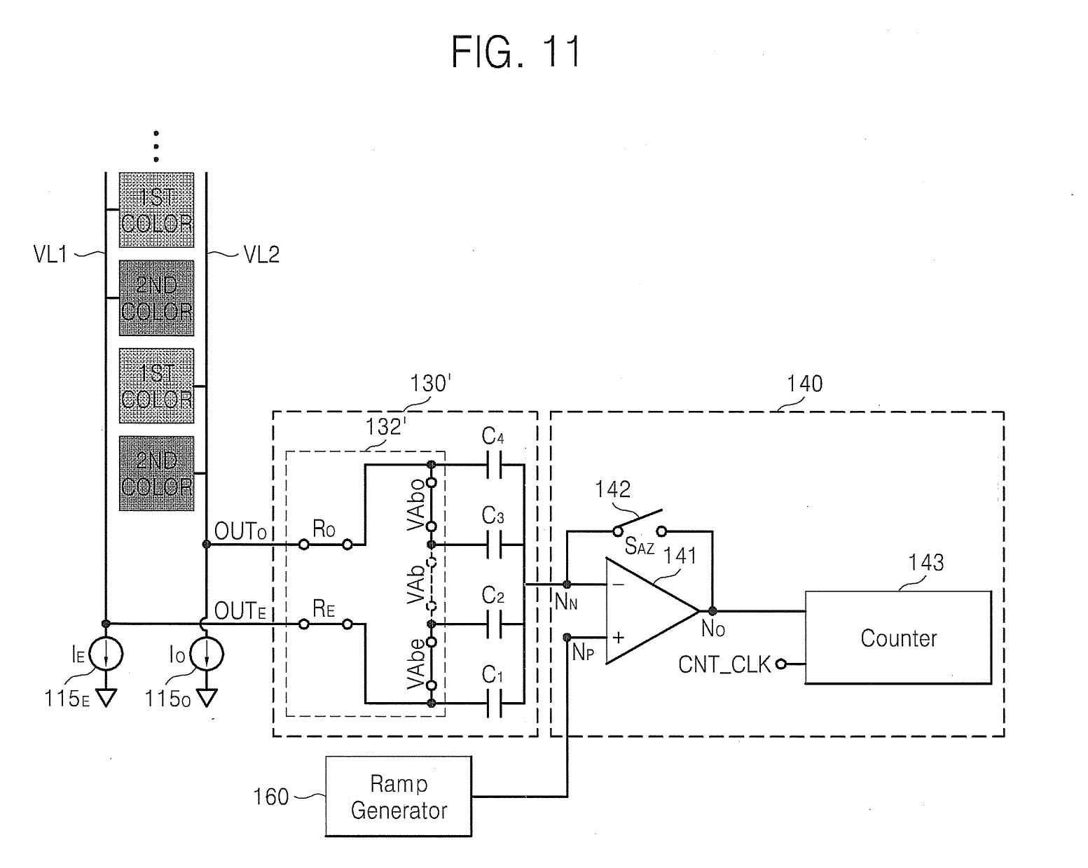

FIG. 11 is a diagram showing a third operation of the CDS block 130′ and the ADC 140 according to an example embodiment. The third operation is a high-speed averaging mode.

Referring to FIG. 11, the first switch R_{E} and the second switch R_{O} are both closed, the first readout line VL1 is connected to the first capacitor C1, and the second readout line VL2 is connected to the fourth capacitor C4. The fourth switch VAb is open. However, the third and fifth switches VAbe and VAbo are closed. Accordingly, the first and second capacitors C1 and C2 are connected in parallel to the first readout line VL1, and the third and fourth capacitors C3 and C4 are connected in parallel to the second readout line VL2. The first and second capacitors C1 and C2 are charged with charge output from a pixel connected to the first readout line VL1, and the third and fourth capacitors C3 and C4 are charged with charge output from a pixel connected to the second readout line VL2.

In this example, assume the capacitances of the first and fourth capacitors C1 and C4 are equal, and the capacitances of the second and third capacitors C3 and C4 are equal. Under this assumption, when the switch 142 is closed, a potential generated at the first input N_{N} of the comparator 141 by charges in the first through fourth capacitors C1, C2, C3 and C4 is the average of (1) the charges stored in the first and second capacitors C1 and C2 and (2) the charges stored in the third and fourth capacitors C3 and C4. The comparator 141 compares the average with a value of the ramp signal Vramp input to the second input terminal N_{P} and outputs a comparison result signal to the output terminal N_{O}.

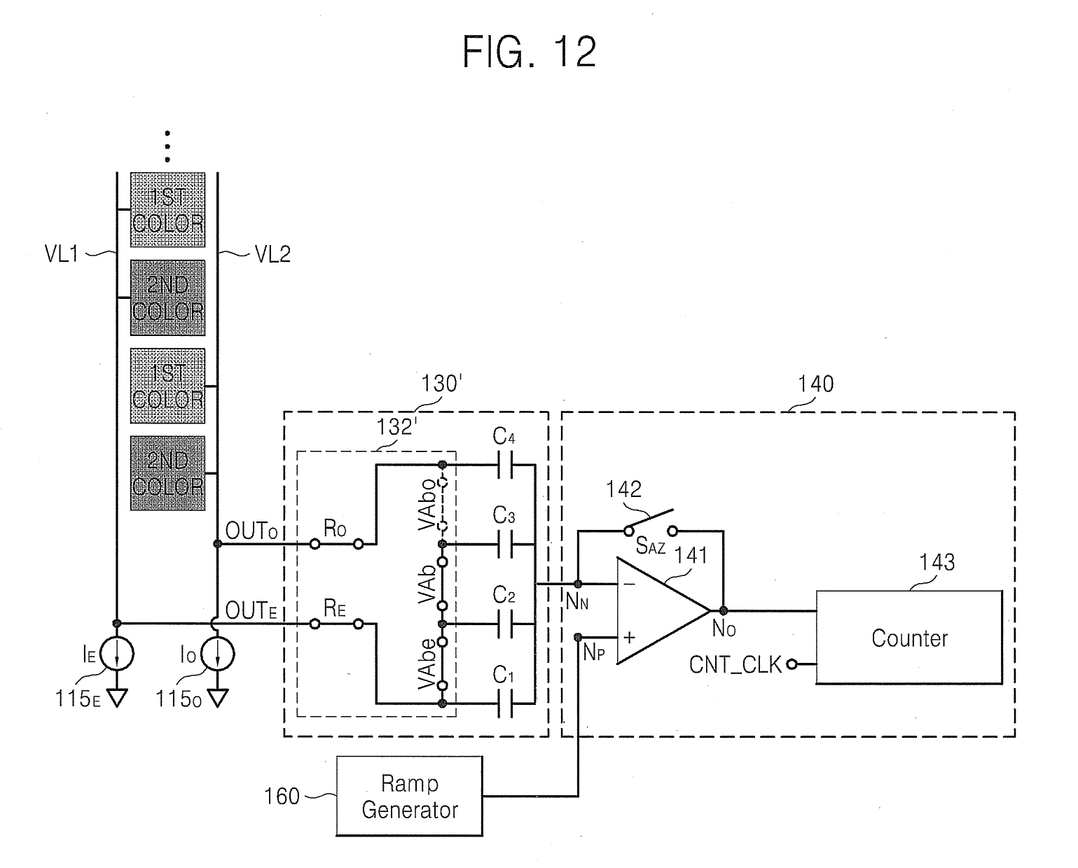

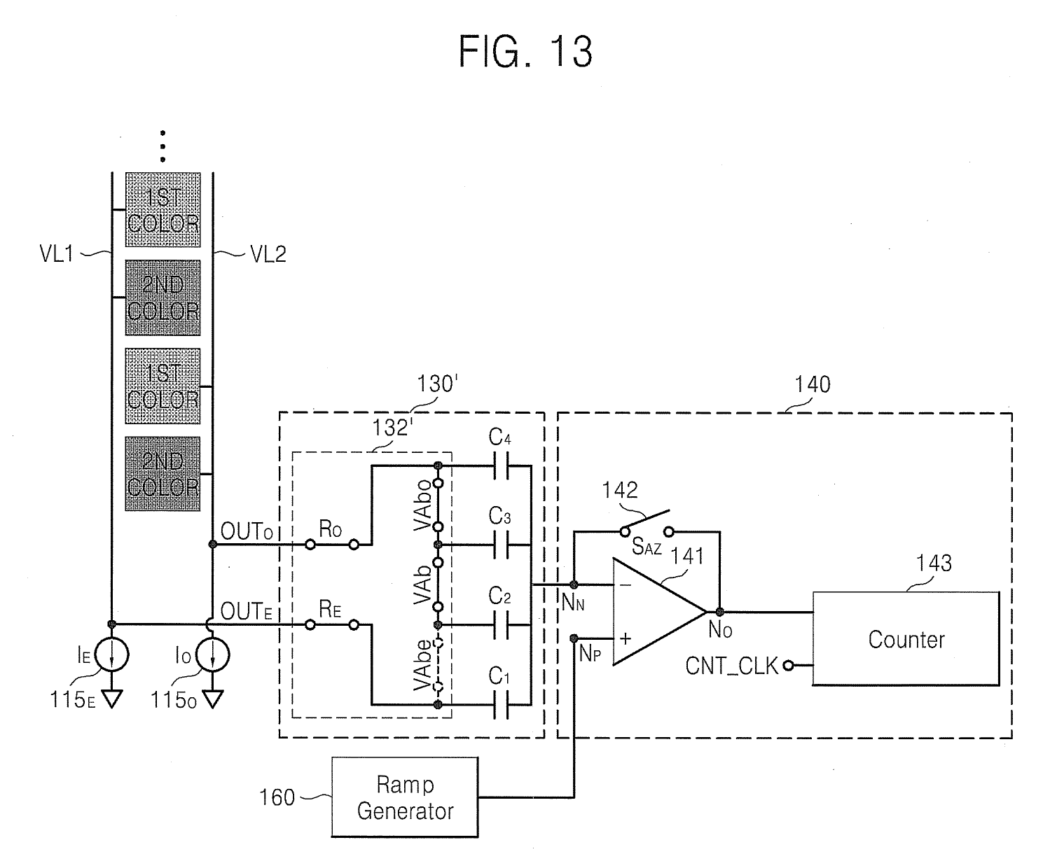

It will be appreciated that the assumption regarding the capacitances of the first through fourth capacitors C1, C2, C3, and C4 may be changed to create a weighted average of the charges. Alternative weighted averaging operations are described in detail below with respect to FIGS. 12 and 13.

FIG. 12 is a diagram showing a fourth operation of the CDS block 130′ and the ADC 140 according to an example embodiment. The fourth operation is a weighted high-speed averaging mode.

Referring to FIG. 12, the first switch R_{E} and the second switch R_{O} are both closed, the first readout line VL1 is connected to the first capacitor C1, and the second readout line VL2 is connected to the fourth capacitor C4. The fifth switch VAbo is open, and the third and fourth switches VAbe and VAb are closed. Accordingly, the first, second and third capacitors C1, C2 and C3 are connected in parallel to the first readout line VL1, and the fourth capacitor C4 alone is connected to the second readout line VL2. The first, second and third capacitors C1, C2 and C3 are charged with charge output from a pixel connected to the first readout line VL1, and the fourth capacitor C4 is charged with charge output from a pixel connected to the second readout line VL2.

When the switch 142 is closed, a potential generated at the first input terminal N_{N} of the comparator 141 by charges in the first through fourth capacitors C1, C2, C3 and C4 is a weighted average according to expression (1) below:

((C1+C2+C3)Dₑ+C4D_{O})/(C1+C2+C3+C4) (1)

where Dₑ is the difference between a reset state of OUT_{E} and a signal state of OUT_{E} and D_{O} is the difference between a reset state of OUT_{O} and a signal state of OUT_{O}. If the capacitances of the first and fourth capacitors C1 and C4 are equal, and the capacitances of the second and third capacitors C3 and C4 are equal, then under this assumption expression (1) reduces to expression (2) below:

(3Dₑ+D_{O})/4 (2)

The comparator 141 compares the weighted average with a value of the ramp signal Vramp input to the second input terminal N_{P} and outputs a comparison result signal to the output terminal N_{O}.

FIG. 13 is a diagram showing a fifth operation of the CDS block 130′ and the ADC 140 according to an example embodiment. The fifth operation is a weighted high-speed averaging mode.

Referring to FIG. 13, the first switch R_{E} and the second switch R_{O} are both closed, the first readout line VL1 is connected to the first capacitor C1, and the second readout line VL2 is connected to the fourth capacitor C4. The third switch VAbe is open, and the fourth and fifth switches VAb and VAbo are closed. Accordingly, the second, third and fourth capacitors C2, C3 and C4 are connected in parallel to the second readout line VL2, and the first capacitor C1 alone is connected to the first readout line VL1. The second, third and fourth capacitors C2, C3 and C4 are charged with charge output from a pixel connected to the second readout line VL2, and the first capacitor C1 is charged with charge output from a pixel connected to the first readout line VL1.

When the switch 142 is closed, a potential generated at the first input terminal N_{N} of the comparator 141 by charges in the first through fourth capacitors C1, C2, C3 and C4 is a weighted average according to expression (3) below:

((C2+C3+C4)D_{O}+C1Dₑ)/(C1+C2+C3+C4). (3)

If the capacitances of the first and fourth capacitors C1 and C4 are equal, and the capacitances of the second and third capacitors C3 and C4 are equal, then under this assumption expression (3) reduces to expression (4) below:

(3D_{O}+Dₑ)/4 (4)

The comparator 141 compares the weighted average with a value of the ramp signal Vramp input to the second input terminal N_{P} and outputs a comparison result signal to the output terminal N_{O}.

As will be appreciated, the weight center (or average) during normal averaging of, for example, a pixel array arranged according to the well-known bayer color pattern results in different distances between the weight center (or average) and the colors being averaged during color interpolation. As such aliasing and false color may occur after color interpolation. However, the weighted average approach of the above described embodiment reduces this aliasing and false color.

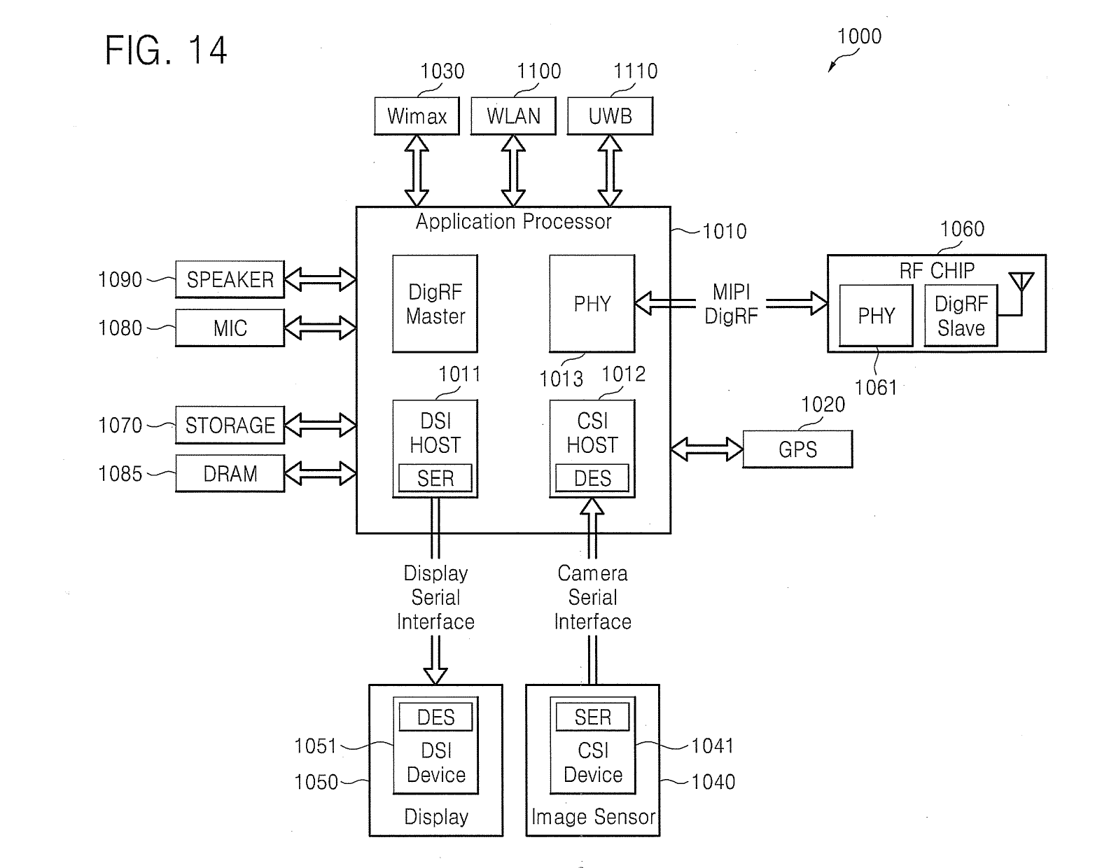

FIG. 14 is a block diagram of an electronic system 1000 including an image sensor according to some embodiments of the present invention. The electronic system 1000 may be implemented in a data processing device, such as a mobile phone, a personal digital, MP3 netbook, laptop, IPTV, video conference equipment, assistant (PDA), a portable media player (PMP), or a smart phone, which can use or support mobile industry processor interface (MIPI). The electronic system 1000 includes an application processor 1010, an image sensor 1040, and a display 1050.

A camera serial interface (CSI) host 1012 implemented in the application processor 1010 can perform serial communication with a CSI device 1041 included in the image sensor 1040 through CSI. At this time, an optical deserializer and an optical serializer may be implemented in the CSI host 1012 and the CSI device 1041, respectively.

A display serial interface (DSI) host 1011 implemented in the application processor 1010 can perform serial communication with a DSI device 1051 included in the display 1050 through DSI. At this time, an optical serializer and an optical deserializer may be implemented in the DSI host 1011 and the DSI device 1051, respectively.

The electronic system 1000 may also include a radio frequency (RF) chip 1060 communicating with the application processor 1010. A physical layer (PHY) 1013 of the application processor 1010 and a PHY 1061 of the RF chip 1060 can communicate data with each other according to MIPI DigRF.

The electronic system 1000 may further include a global positioning system (GPS) 1020, a storage 1070, a microphone (MIC) 1080, a dynamic random access memory (DRAM) 1085, and a speaker 1090. The electronic system 1000 may communicate using a Worldwide interoperability for microwave access (Wimax) 1030, a wireless local area network (WLAN) 1100, and an ultra-wideband (UWB) 1110.

As described above, according to some embodiments of the present invention, an image sensor and an electronic system including the same provide high readout speed without high power consumption and chromatic loss.

While the present invention has been particularly shown and described with reference to exemplary embodiments thereof, it will be understood by those of ordinary skill in the art that various changes in forms and details may be made therein without departing from the spirit and scope of the present invention as defined by the following claims.

1. A pixel array, comprising:
a plurality of pixels arranged in columns;
a plurality of read out lines associated with the plurality of pixels such that each column of pixels has at least two read out lines associated therewith; and
for each column of pixels,
the two associated read out lines configured to transfer signals in a same direction.

2. The pixel array of claim 1, wherein, for each column of pixels, first and second read out lines of the two associated read out lines are connected to different pixels in the column of pixels.

3. The pixel array of claim 2, wherein for a column of pixels, consecutive pixels of a same color are associated with different ones of the two associated read out lines, the consecutive pixels of the same color do not have a pixel of the same color there between.

4. The pixel array of claim 2, wherein, for each column of pixels, the first and second read out lines of the two associated read out lines are electrically connected to a same analog-to-digital converter.

5. The pixel array of claim 1, wherein for a column of pixels, consecutive pixels of a same color are associated with different ones of the two associated read out lines.

6. The pixel array of claim 1, wherein, for each column of pixels, the two associated read out lines are electrically connected to a same analog-to-digital converter.

7-12. (canceled)

13. A read out circuit for a pixel array, comprising:
at least first and second capacitors;
a switching structure configured to selectively connect first and second read out lines associated with a same column of pixels in the pixel array to the first and second capacitors.

14. The read out circuit of claim 13, wherein the switching structure is configured to selectively connect the first and second capacitors in parallel to one of the first read out line and the second read out line in an operation mode.

15. The read out circuit of claim 13, wherein the switching structure is configured to selectively connect the first read out line to the first capacitor and the second read out line to the second capacitor in an operation mode

16. The read out circuit of claim 13, further comprising:
a comparator, a first input of the comparator connected to the first and second capacitors, and a second input of the comparator receives a ramp signal;
a counter configured to receive output from the comparator; and
a switch configured to selectively connect the output from the comparator to the first input of the comparator.

17. The read out circuit of claim 16, further comprising:
a buffer configured to store output of the counter.

18. The read out circuit of claim 13, wherein the switching structure comprises:
a first switch connected between the first read out line and the first capacitor;
a second switch connected between the second read out line and the second capacitor;
a third switch connected between the first and second capacitors.

19. The read out circuit of claim 18, wherein the first and second capacitors have a same capacitance.

20. The read out circuit of claim 13, further comprising:
third and fourth capacitors; and wherein
the switching structure is configured to selectively connect the first and second read out lines to the first, second, third and fourth capacitors.

21. The read out circuit of claim 20, wherein in a first mode, the switching structure is configured to selectively connect the first, second, third and fourth capacitors to the first and second read out lines such that signals on the first and second read out lines are combined according to a weighted average.

22. The read out circuit of claim 21, wherein in a second mode, the switching structure is configured to selectively connect the first, second, third and fourth capacitors to the first and second read out lines such that signals on the first and second read out lines are averaged.

23. The read out circuit of claim 20, wherein in a first mode, the switching structure is configured to selectively connect the first, second, third and fourth capacitors to the first and second read out lines such that signals on the first and second read out lines are averaged.

24. The read out circuit of claim 20, wherein in one operation mode, the switching structure is configured to connect the first, second, third and fourth capacitors in parallel to one of the first read out line and the second read out line.

25. The read out circuit of claim 20, wherein in one operation mode, the switching structure is configured to connect the first and second capacitors in parallel to the first read out line, and connect the third and fourth capacitors in parallel to the second read out line.

26. The read out circuit of claim 20, wherein in one operation, the switching structure is configured to connect the first, second and third capacitors in parallel to the first read out line, and connect the fourth capacitor to the second read out line; and

27. The read out circuit of claim 20, wherein in one operation mode, the switching structure is configured to connect the first capacitor to the first read out line, and connect the second, third and fourth capacitors in parallel to the second read out line.

28. The read out circuit of claim 20, wherein the switching structure comprises:
a first switch connected between the first read out line and the first capacitor;
a second switch connected between the second read out line and the fourth capacitor;
a third switch connected between the first and second capacitors;
a fourth switch connected between the second and third capacitors; and
a fifth switch connected between the third and fourth capacitors.

29. The read out circuit of claim 28, wherein the first and fourth capacitors have a same capacitance, and the second and third capacitors have a same capacitance.

30-67. (canceled)

68. A method of reading information from a pixel array, comprising:
in a normal mode,
reading out a signal from a pixel in a first group of pixels in a column of pixels using a first read out line and a read out circuit; and
subsequently reading out a signal from a pixel in a second group of pixels in the column of pixels using a second read out line and the read out circuits.

69. The method of claim 68, further comprising:
in a combination mode,
reading out a signal from pixels in the first and second groups of pixels using the first and second read out lines; and
combining the read signals from the first and second read out lines.

70. The method of claim 69, wherein
the combining averages the read signals from the first and second read out lines.

71. The method of claim 69, wherein
the combining obtains a weighted average of the read signals from the first and second read out lines.

72. The method of claim 69, wherein the reading out step in the combination mode reads a pixel in the first group and pixel in the second group having a same color.

73. The method of claim 68, further comprising:
comparing the combined read signals to a ramp signal; and
counting based on results of the comparing.

74. The method of claim 73, further comprising:
buffing results of the counting.
